(19) United States
(12) Patent Application Publication
(10) Pub. No.: US 2016/0226064 A1
(43) Pub. Date: Aug. 4, 2016

(54) LITHIUM ION RECHARGEABLE BATTERY

(71) Applicant: TOYOTA JIDOSHA KABUSHIKI KAISHA, Toyota-shi, Aichi (JP)

(72) Inventor: Masanori Kitayoshi, Toyota-shi (JP)

(73) Assignee: TOYOTA JIDOSHA KABUSHIKI KAISHA, Toyota-shi, Aichi (JP)

(21) Appl. No.: 15/026,492

(22) PCT Filed: Sep. 10, 2014
(86) PCT No.: PCT/JP2014/004644

§ 371 Date: Mar. 31, 2016

(30) Foreign Application Priority Data
Oct. 2, 2013 (JP) 2013-206951

(51) Int. Cl. H01M 4/36; H01M 4/139; H01M 4/13; H01M 10/0525; H01M 4/04

(52) U.S. Cl. CPC H01M 4/366; H01M 10/0525; H01M 4/0404; H01M 4/13; H01M 4/139; H01M 2220/20

(57) ABSTRACT

A lithium ion rechargeable battery that promotes reactivity on a current collector side of an electrode and improves a constant output discharge performance includes an electrode with a lower layer formed of a first active material and a second active material having a conductivity different from that of the first active material, and an upper layer formed of the first and second active materials. The lower layer is formed by alternately applying a first lower layer-forming slurry containing the first active material and a second lower layer-forming slurry containing the second active material in a stripe shape on a current collector, and the upper layer is formed by a first upper layer-forming slurry containing the first active material applied on the second lower layer-forming slurry in multiple layers and a second upper layer-forming slurry containing the second active material applied on the first lower layer-forming slurry in multiple layers.

### TECHNICAL FIELD

The present invention relates to a lithium ion rechargeable battery, and more particularly, to a lithium ion rechargeable battery in which discharge characteristics are improved.

### BACKGROUND ART

In recent years, there has been a growing need for rechargeable batteries used for hybrid cars, electric cars, and accumulation of power which have a high capacity, a small size and a low weight. Among the rechargeable batteries, the current focus is on lithium ion rechargeable batteries as they are considered the most important rechargeable batteries since it has been possible to achieve a higher capacity and a higher output in the lithium ion rechargeable batteries. It has been demanded that the capacity and the output in the lithium ion rechargeable batteries be further increased.

One of the techniques to improve the electric capacity of the lithium ion rechargeable battery is to provide a thick-film electrode in which a positive electrode active material layer or a negative electrode active material layer is formed on a current collector in such a way that the layer has as great a thickness as possible. Related techniques to promote the reaction of the thick electrode on the upper layer (electrolyte side) include, for example, Patent Literature 1 and 2.

Patent Literature 1 discloses an electrode in which a solid concentration decreases from a side of a current collector to an upper layer (electrolyte side) in an active material layer of a thick electrode. Patent Literature 2 discloses an electrode in which an active material having a small particle diameter is arranged in an upper layer (electrolyte side) in an active material layer of a rechargeable battery and a part having void sizes different from one another is provided.

### CITATION LIST

### Non Patent List

### [Patent Literature 1] Japanese Unexamined Patent Application Publication No. 2005-050755

### [Patent Literature 2] Japanese Unexamined Patent Application Publication No. 2011-175739

### SUMMARY OF INVENTION

### Technical Problem

When the lithium ion rechargeable battery is discharged at a high rate, much Li ion is consumed in the positive electrode surface layer (electrolyte side), which causes a so-called “lack of electrolyte solution” and results in discharge defects. This is because Li ion concentration is intensively consumed on the surface layer of the electrode. Since the active material located around the surface of the electrode selectively reacts in the surface layer active material layer in the thick electrode, it is difficult to sufficiently promote the performance of the active material on the side of the current collector and improve output corresponding to the thickness of the active material layer.

According to the methods disclosed in Patent Literature 1 and 2, the reactivity of the upper layer (electrolyte side) of the active material layer of the thick electrode increases in a short time in the lithium ion rechargeable battery. However, Patent Literature 1 and 2 do not consider a way to mitigate the reaction to the current collector side. Therefore, when a constant power discharge is carried out for a certain period of time, the reaction of the lower layer part (current collector side) decreases, and the speed of the decrease in the voltage of the battery increases.

The present invention has been made in view of the aforementioned problem and provides a lithium ion rechargeable battery that promotes reactivity on a side of a current collector of an electrode and improves a constant output discharge performance.

### Solution to Problem

A lithium ion rechargeable battery according to one aspect of the present invention includes an electrode, the electrode including: a lower layer formed of a first active material and a second active material having a conductivity different from that of the first active material; and an upper layer formed of the first active material and the second active material, in which the lower layer is formed by alternately applying a first lower layer-forming slurry that contains the first active material and a second lower layer-forming slurry that contains the second active material in a stripe shape on a current collector, and the upper layer is formed by a first upper layer-forming slurry that contains the first active material applied on the second lower layer-forming slurry in multiple layers and a second upper layer-forming slurry that contains the second active material applied on the first lower layer-forming slurry in multiple layers.

### Advantageous Effects of Invention

According to the present invention, it is possible to provide a lithium ion rechargeable battery that promotes reactivity on a side of a current collector of an electrode and improves a constant output discharge performance.

### BRIEF DESCRIPTION OF DRAWINGS

FIG. 1 is a schematic view showing an electrode 1 of a lithium ion rechargeable battery according to a first embodiment of the present invention;

FIG. 2 is a partial view of the cross section of the electrode 1 according to the first embodiment of the present invention;

FIG. 3 is a graph showing some reaction characteristics of the lithium ion rechargeable battery when a pattern of the electrode 1 is changed according to the first embodiment of the present invention;

FIG. 4 is a cross-sectional view of the electrode 1 when a pattern of the electrode 1 is changed according to the first embodiment of the present invention;

FIG. 5 is a cross-sectional view of an electrode 2 when a pattern of the electrode 2 is changed according to a second embodiment of the present invention;

FIG. 6 is a cross-sectional view of an electrode 3 when a pattern of the electrode 3 is changed according to a third embodiment of the present invention;

FIG. 7 is a compounding ratio of paste of an active material when a first layer 5 and a second layer 6 are formed on a current collector 12 of the electrode 1 using gravure pattern printing according to the first embodiment of the present invention;

FIG. 8 is a schematic view showing a method of applying paste that contains the active material on the current collector 12 using gravure pattern printing according to the first embodiment of the present invention; and

FIG. 9 is a schematic view showing a lithium ion rechargeable battery 100 according to the first embodiment of the present invention.

### DESCRIPTION OF EMBODIMENTS

### First Embodiment

Hereinafter, with reference to the drawings, a first embodiment of the present invention will be described. FIG. 9 is a schematic view showing a lithium ion rechargeable battery 100 according to the first embodiment of the present invention. The lithium ion rechargeable battery 100 includes an electrode 1 (anode), an electrode 40 (cathode), and an electrolyte 50.

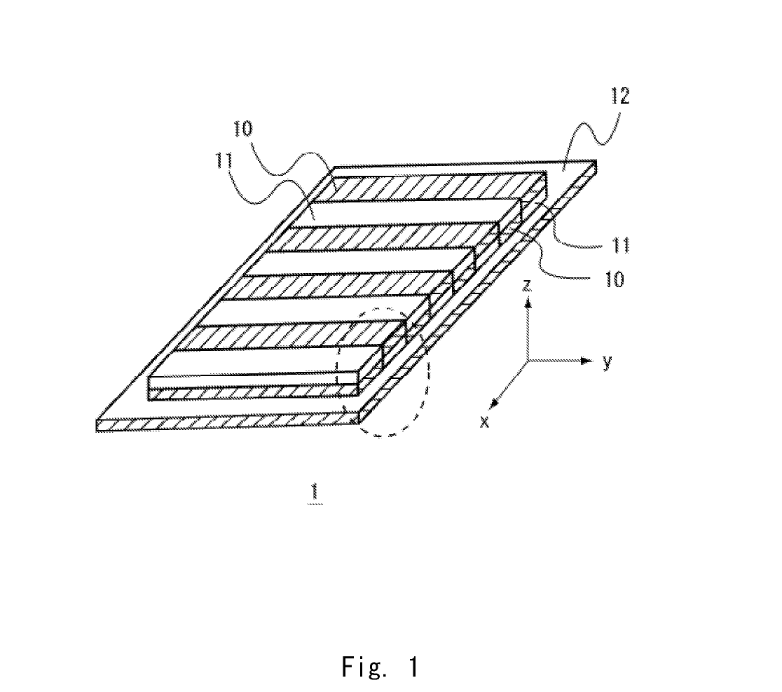

FIG. 1 is a schematic view showing the electrode 1 of the lithium ion rechargeable battery according to the first embodiment of the present invention.

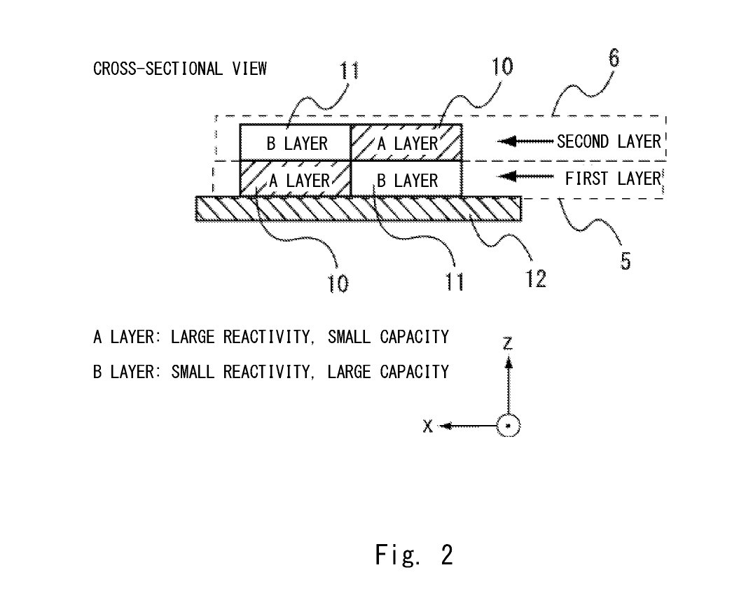

The electrode 1 includes a current collector 12 formed of metallic foil, a first layer 5 (lower layer) having one surface side formed on the current collector, and a second layer 6 (upper layer) formed on the other surface side of the first layer. FIG. 2 is a cross-sectional view of the electrode 1 showing a part surrounded by the circle shown in FIG. 1. As shown in FIGS. 1 and 2, the first layer 5 is formed of an A layer 10 (layer including a first active material) and a B layer 11 (layer including a second active material) having a conductivity different from that of the A layer 10.

The first layer 5 includes a plurality of strip-shaped A layers 10 having a constant width and a plurality of strip-shaped B layers 11 having a constant width alternately arranged therein and has a stripe shape.

The second layer 6 has a configuration similar to that of the first layer 5 formed of the A layers 10 and the B layers 11. The A layer 10 of the second layer 6 is formed on the other surface side of the B layer 11 of the first layer 5 and the B layer 11 of the second layer 6 is formed on the other surface side of the A layer 10a of the first layer 5. That is, in the electrode 1, the A layers 10 and the B layers 11 are alternately arranged with respect to the z-axis direction and the y-axis direction from the side of the current collector 12.

The A layer 10 is an active material in which the reactivity is large and the capacity is small. The A layer 10 is formed to include the active material having a small particle diameter (2 to 5 μm).

The B layer 10 is an active material in which the reactivity is small and the capacity is large. The B layer 11 is formed to include the active material having a large particle diameter (7 to 12 μm). The active material may be, for example, LiNi_{1/3}Mn_{1/3}Co_{1/3}O₂.

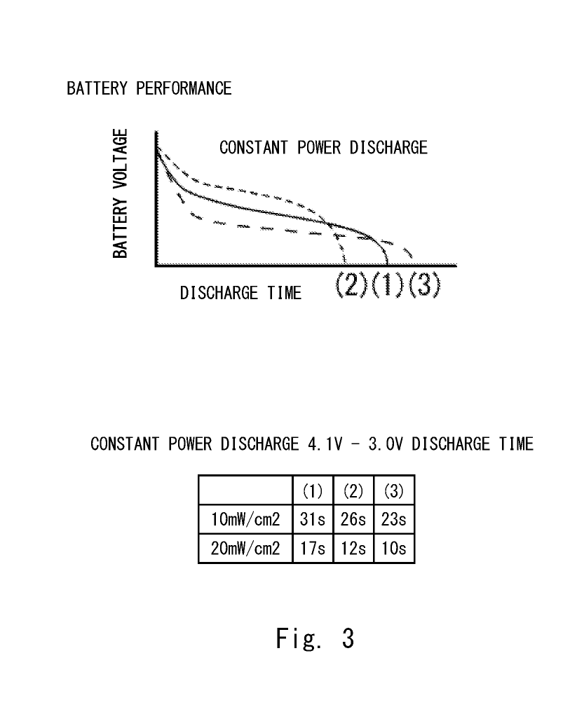

Next, the reaction of the electrode surface layer when a high-rate discharge is performed in the lithium ion rechargeable battery 100 will be described. FIG. 3 is a graph showing some reaction characteristics of the lithium ion rechargeable battery when each electrode shown in (1) to (3) described later is used. The graph in FIG. 3 shows a variation of voltage with time when the lithium ion rechargeable battery is discharged at a constant power when each electrode shown in (1) to (3 ) described later is used.

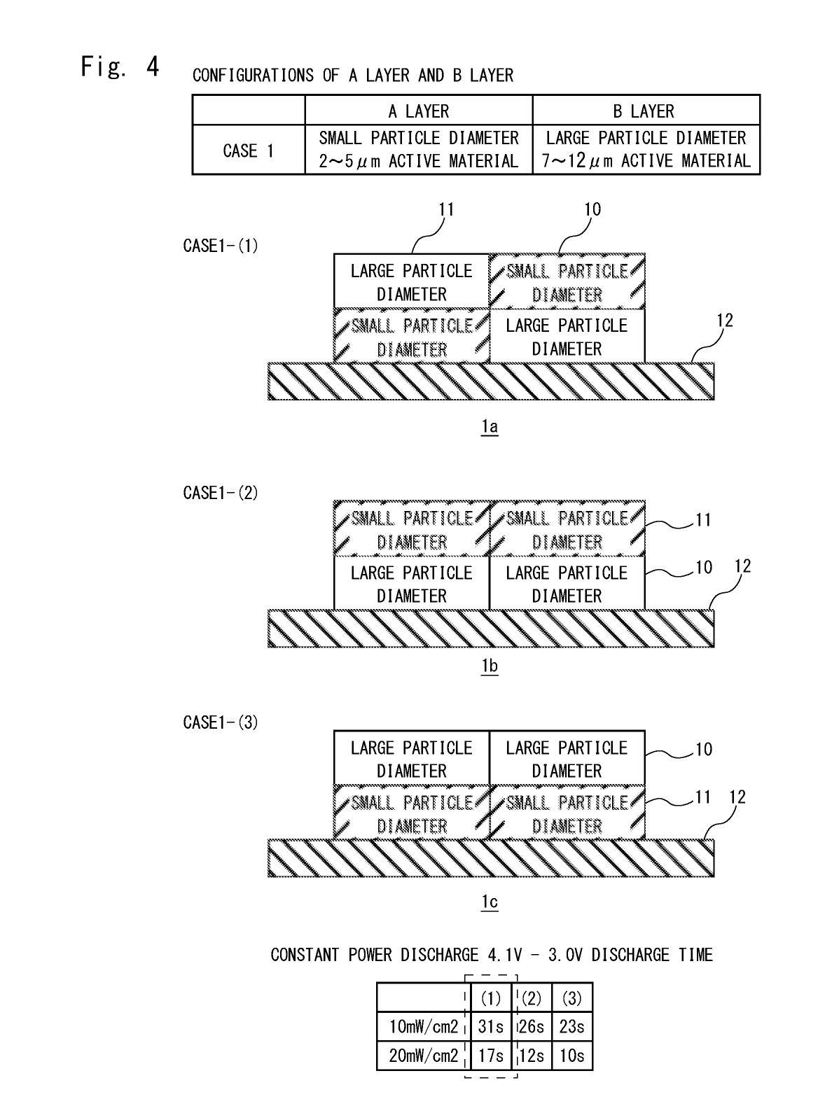

FIG. 4 is a cross-sectional view of electrodes 1a, 1b, and 1c when each electrode is formed to have the patterns of (1) to (3). The table shown in FIG. 4 shows a reaction time in the case of (1) to (3) when the lithium ion rechargeable battery 100 of each electrode is discharged at a constant power and the voltage decreases from 4.1 V to 3.0 V. The unit of the set power value is obtained by dividing a set power value to be output by an effective area of each electrode (mW/cm²).

First, as shown in Case 1-(2) in FIG. 4, a case in which the electrode 1b is formed of the second layer formed of only the A layers 10 and the first layer formed of only the B layers will be described. As shown in FIG. 3, when the electrode is as shown in (2) at the time of discharge, the average reaction voltage increases. However, the reaction at the time of discharge occurs in around the surface layer (side of the electrolyte 50) of the A layer 10, which causes a so-called “lack of electrolyte solution”. Then as shown in FIG. 3 and the table in FIG. 4, in the electrode lb formed by the pattern of (2), the reactivity of the whole electrode decreases and the discharge time becomes short.

Next, as shown in Case 1-(3) in FIG. 4, a case in which the electrode 1c is formed of the second layer formed of only the B layers 11 and the first layer formed of only the A layers 10 will be described. As shown in FIG. 3 and the table in FIG. 4, when the electrode is as shown in (3) at the time of discharge, the voltage abruptly decreases and reaches the lower-limit voltage (stops when the voltage reaches 3 V). On the other hand, in the electrode formed by the pattern of (3), the reaction becomes dull in the electrode lower layer (current collector side) and the reaction time when the voltage is equal to or larger than 3 V increases. That is, while the reaction average voltage decreases in the electrode where the upper layer is formed of the B layers 11, the reaction time in the electrode lower layer increases (3). In this way, the electrode formed of the A layers 10 and the B layers 11 have both advantages and disadvantages.

Next, discharge characteristics of a case in which the electrode 1 (electrode 1a) according to the first embodiment of the present invention is used will be described (1). When the A layers 10 and the B layers 11 are alternately arranged in two layers, as shown in Case 1-(1) in FIG. 4, the reaction indicating the characteristics intermediate between those of (2) and (3), as shown in FIG. 3 and the table in FIG. 4, is obtained. That is, the electrode la exhibits the characteristics in which the average voltage is higher than that of (3) and the discharge time until when the voltage reaches the lower-limit voltage (3.0 V) is longer than that of (2).

As stated above, by using the electrode 1 according to this embodiment, the reactivity on the side of the electrolyte 50 and the side of the current collector is promoted, whereby the lithium ion rechargeable battery 100 in which the constant output discharge performance is improved is obtained.

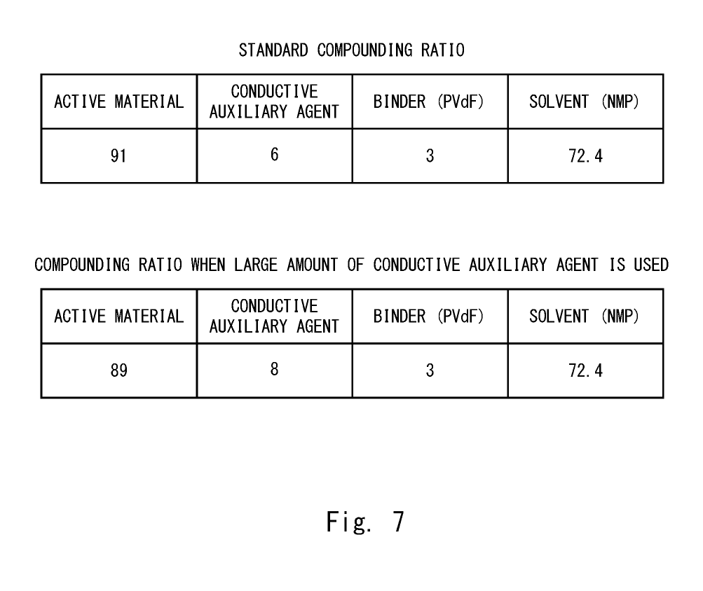

Next, with reference to the drawings, a method of manufacturing the electrode 1 according to this embodiment will be described. FIG. 7 shows a compounding ratio of the slurry (paste) of the active material when the first layer 5 and the second layer 6 are formed on the current collector 12 of the electrode 1 using gravure pattern printing according to this embodiment. LiNi_{1/3}Mn_{1/3}Co_{1/3}O₂ is used as the active material. Acetylene black (HS-100) is used as the conductive auxiliary agent. Polyvinylidene fluoride (PVdF) is used as the binder. N-methyl-2-pyrrolidone (NMP) is used as the solvent.

Next, a method of preparing the slurry (paste) including the active material will be described. A slurry producing device is used to produce the slurry. This device may be a typical planetary mixer.

First, the active material and the conductive auxiliary agent are mixed. Then binder is input to the mixed material and the mixture is kneaded. Further, NMP is injected into the kneaded material and the mixture is further mixed and kneaded. According to the above processes, the slurry that contains the active material is obtained.

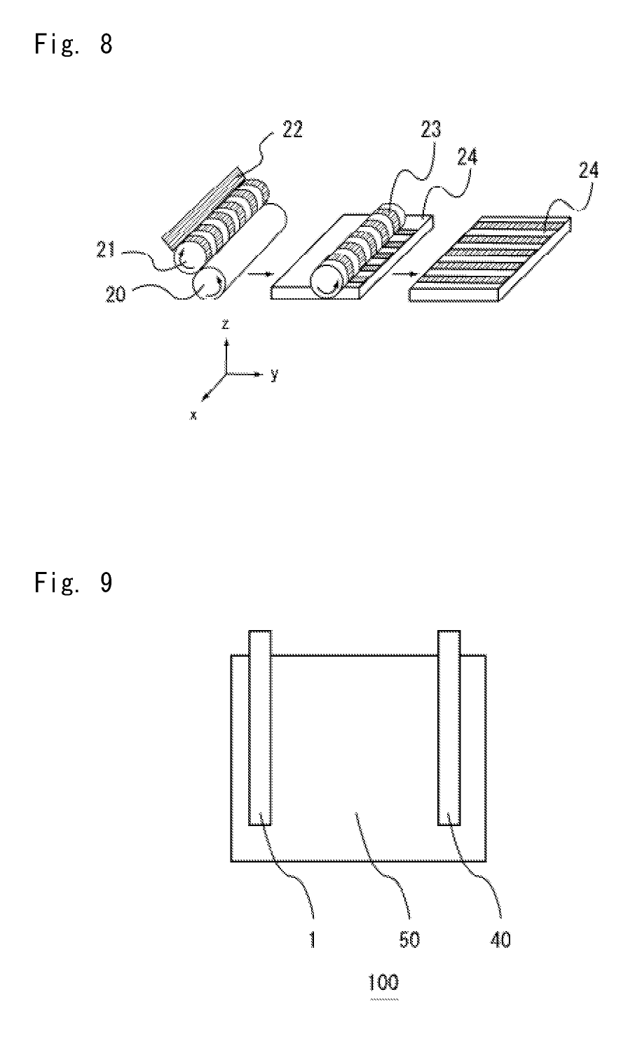

Next, a method of applying the slurry 23 that contains the active material onto the current collector 12 (in this embodiment, aluminium foil 24) will be described. FIG. 8 is a schematic view showing the method of applying the slurry that contains the active material onto the current collector 12 using the gravure pattern printing.

First, the slurry 23 is rotated in a clockwise direction about the x axis while the slurry 23 is being uniformly applied to the lower part of a gravure roll 21 (−z direction) in the x direction. The slurry 23 is then scraped at certain intervals by a doctor blade 22 having grooves at certain intervals while the gravure roll 21 is being rotated. The slurry 23 that has been scraped at certain intervals is transferred to a blanket roll 20. The slurry 23 that has been transferred to the blanket roll 20 is then transferred and applied to the aluminium foil 24 in a stripe shape. The condition for applying the slurry is, for example, 0.8 m/min. The condition for dying the slurry 23 after it is applied is, for example, 180 degrees.

The first layer 5 (lower layer) is formed by alternately applying the A layers 10 and the B layers 11 twice to form the A layers 10 that contain the first active material and the B layers 11 that contain the second active material when the electrode lower layer-forming slurry is applied while the compounding ratio of the active material is being changed. That is, the first layer 5 (lower layer) is formed by alternately applying the first lower layer-forming slurry that contains the first active material and the second lower layer-forming slurry that contains the second active material in a strip shape on the current collector.

When the slurry for forming the second layer 6 (upper layer) is applied onto the first layer 5 (lower layer) in multiple layers, the second layer 6 (upper layer) is formed by applying the A layers 10 and the B layers 11 twice, that is, by applying the A layer-forming slurry of the second layer 6 (upper layer) onto the slurry for forming the B layer 11 of the first layer 5 (lower layer) in multiple layers in a stripe shape and further applying the slurry for forming the B layer 11 of the second layer 6 (upper layer) onto the slurry for forming the A layer 10 of the first layer 5 (lower layer) in multiple layers in a stripe shape.

That is, the second layer 6 (upper layer) is formed by the first upper layer-forming slurry that contains the first active material applied on the second lower layer-forming slurry in multiple layers and the second upper layer-forming slurry that contains the second active material applied on the first lower layer-forming slurry in multiple layers.

As stated above, by performing the process of applying slurry four times in total, the electrode 1 according to this embodiment is obtained.

### Second Embodiment

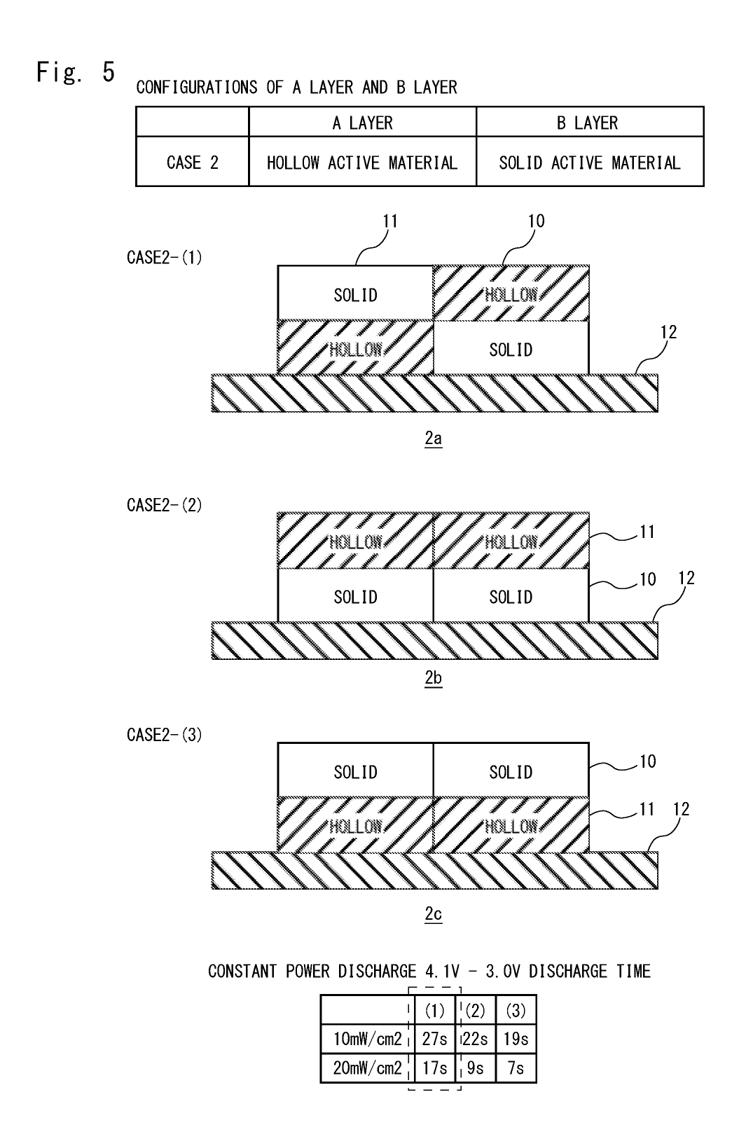

Next, characteristics of an electrode 2, which is obtained by changing the active materials of the A layer 10 and the B layer 11 from those in the first embodiment, will be described. In this embodiment, a hollow active material is used as the A layer 10 and a solid active material is used as the B layer 11. FIG. 5 is a cross-sectional view of electrodes 2a, 2b, and 2c when each electrode is formed to have the patterns of (1) to (3). The experimental method and the patterns (1) to (3) of each electrode are similar to those of the first embodiment, and the overlapping descriptions will be omitted.

FIG. 5 shows a table indicating the discharge time until when the voltage reaches the lower-limit voltage (3.0 V) when a constant power discharge is performed. As shown in the table of FIG. 5, the discharge time of the electrode 2a shown in the pattern of (1) is the longest.

As described above, by using the electrode 2 according to this embodiment, the reactivity on the side of the electrolyte 50 and the side of the current collector is promoted, whereby the lithium ion rechargeable battery in which the constant output discharge performance is improved is obtained.

### Third Embodiment

Next, characteristics of an electrode 3, which is obtained by changing the active materials of the A layer 10 and the B layer 11 from those in the first embodiment, will be described. In this embodiment, an active material that contains a large amount of carbon is used as the A layer 10 and an active material that contains a small amount of carbon is used as the B layer 11.

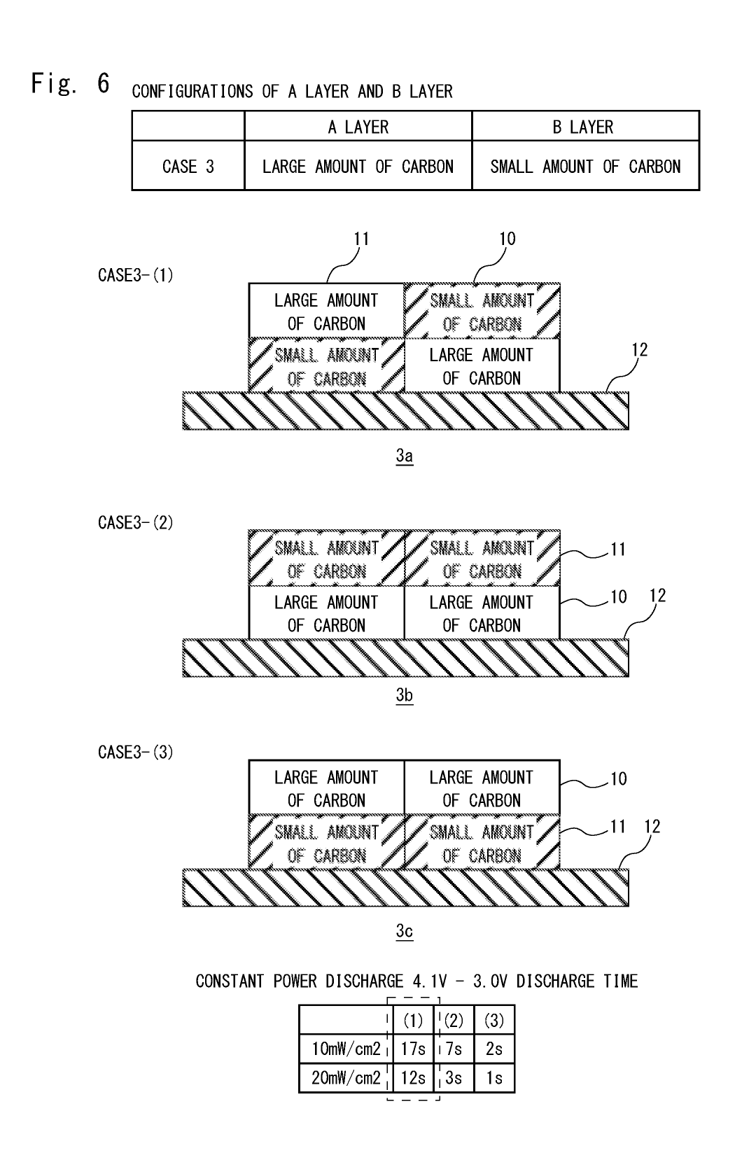

FIG. 6 is a cross-sectional view of electrodes 3a, 3b, and 3c when each electrode is formed to have the patterns of (1) to (3). The experimental method and the patterns (1) to (3) of each electrode are similar to those of the first embodiment, and the overlapping descriptions will be omitted.

FIG. 6 shows a table indicating the discharge time until when the voltage reaches the lower-limit voltage (3.0 V) when a constant power discharge is performed. As shown in the table of FIG. 6, the discharge time of the electrode 3a shown in the pattern of (1) is the longest.

As described above, by using the electrode 3 according to this embodiment, the reactivity on the side of the electrolyte 50 and the side of the current collector is promoted, whereby the lithium ion rechargeable battery in which the constant output discharge performance is improved is obtained.

This application is based upon and claims the benefit of priority from Japanese Patent Application No. 2013-206951, filed on Oct. 2, 2013, the disclosure of which is incorporated herein in its entirety by reference.

### REFERENCE SIGNS LIST

### 1 ELECTRODE

### 1a ELECTRODE

### 1b ELECTRODE

### 1c ELECTRODE

### 2a ELECTRODE

### 2b ELECTRODE

### 2c ELECTRODE

### 3a ELECTRODE

### 3b ELECTRODE

### 3c ELECTRODE

### 5 FIRST LAYER (LOWER LAYER)

### 6 SECOND LAYER (UPPER LAYER)

### 10 A LAYER

### 11 B LAYER

### 12 CURRENT COLLECTOR

### 20 BLANKET ROLL

### 21 GRAVURE ROLL

### 22 DOCTOR BLADE

### 23 SLURRY

### 24 METALLIC FOIL

### 40 ELECTRODE (CATHODE)

### 50 ELECTROLYTE

### 100 LITHIUM ION RECHARGEABLE BATTERY

1. A lithium ion rechargeable battery comprising an electrode, the electrode comprising:
a lower layer formed of a first active material and a second active material having a conductivity different from that of the first active material; and
an upper layer formed of the first active material and the second active material, wherein:
the lower layer is formed by alternately applying a first lower layer-forming slurry that contains the first active material and a second lower layer-forming slurry that contains the second active material in a stripe shape on a current collector, and
the upper layer is formed by a first upper layer-forming slurry that contains the first active material applied on the second lower layer-forming slurry in multiple layers and a second upper layer-forming slurry that contains the second active material applied on the first lower layer-forming slurry in multiple layers.
